(19) United States
(12) Patent Application Publication
(10) Pub. No.: US 2023/0418066 A1
(43) Pub. Date: Dec. 28, 2023

(54) MULTIPLEXED VOLUME HOLOGRAM COUPLERS FOR AUGMENTED REALITY WAVEGUIDES

(71) Applicant: Juan Russo, Denver, CO (US)

(72) Inventor: Juan Russo, Denver, CO (US)

(21) Appl. No.: 17/850,983

(22) Filed: Jun. 27, 2022

(51) Int. Cl. G02B 27/01; G03H 1/02

(52) U.S. Cl. CPC G02B 27/0172; G03H 1/0248; G02B 2027/0174; G02B 2027/0178

(57) ABSTRACT

Volume hologram couplers are multiplexed into a same volume to increase the field of view of components in a waveguide assembly such as an augmented reality (AR) waveguide assembly for use in electronic eyewear devices. The multiplexing can be done in any direction perpendicular to the optical axis. Multiplexing of the volume hologram couplers combines different functions of the waveguide assembly into one diffractive optical element (DOE) in the form of an input coupler or an output coupler. For example, each volume holographic grating of input couplers and output couplers has a different refraction angle, a different periodicity, or both relative to any other volume holographic grating in the same volume. The resulting DOEs reduce reinteraction losses, reduce thickness, reduce the amount of DOEs and the number of layers and airgaps, and increase robustness (volume versus surface relief that can scratch or break).

### TECHNICAL FIELD

Examples set forth herein generally relate to volume hologram couplers for waveguides and, in particular, to volume hologram couplers that multiplex multiple volume holograms into a single optical device that achieves the function of separate state-of-the-art volume holograms and increases the field of view of a system including an augmented reality (AR) waveguide.

### BACKGROUND

Volume holograms have been used in AR devices such as eyewear devices with limited eye box sizes and limited fields of view. An eye box is a three-dimensional space within which users place their eye to properly see an entire virtual image without moving the head or making any other adjustment. Multiplexing and layering has been used with diffractive optical elements and combiner optics to achieve multi-color performance, but have not been used to achieve increased field of view or 1-dimensional or 2-dimensional eye box expansion in AR devices.

State of the art technology for augmented reality waveguide combiner optics uses broadband surface relief structures and diffractive optical elements. Specifically, output couplers based on surface relief gratings (SRG) have light incident at angles away from the Bragg condition and hence a low diffraction efficiency. This approach allows multiple interactions with the SRGs and provides eye box expansion. However, the eye box expansion comes at the cost of optical efficiency and increased power draw by the light source of the AR device.

### BRIEF DESCRIPTION OF THE DRAWINGS

In the drawings, which are not necessarily drawn to scale, like numerals may describe similar components in different views. Some nonlimiting examples are illustrated in the figures of the accompanying drawings in which:

FIGS. 1A-1E are graphs illustrating thickness (d) versus diffraction angle for gratings showing that increasing thickness of a diffractive optical element increases the diffraction efficiency but reduces the bandwidth in angle and wavelength.

FIGS. 2A-2C are illustrations of volume gratings in which several structures are multiplexed in the same volume yet operate independently.

FIG. 3A is an illustration of a diffractive optical element (DOE) used in Augmented Reality (AR) glasses for trapping light in a waveguide by total internal reflection (TIR) and forcing the light out at a desired position, such as in front of the eyes of the user.

FIG. 3B is an illustration of the presentation of a real or AR image to the user's eye in an eye box.

FIG. 4 illustrates the operation in reflection mode of a matched input coupler (IC) and output coupler (OC) whereby light incident on the IC (kp) is diffracted (kd) at an angle larger than the critical angle and is trapped in the waveguide by TIR.

FIGS. 5A and 5B are plots of the angle of incidence and diffraction of light on a matched IC/OC waveguide assembly using single volume holographic gratings and the corresponding intensity of the light diffraction.

FIGS. 6A and 6B are illustrations of volume gratings showing IC-OC matching in transmission mode of the matched IC and OC of FIG. 4.

FIG. 7 is an illustration of a waveguide where each arrow pointing up represents an image that is extracted from the waveguide every time the light wave trapped by TIR interacts with the OC.

FIG. 8 is an illustration of fold gratings in an example configuration.

FIGS. 9A and 9B are illustrations of volume gratings that use multiplexing to allow multiple gratings to occupy the same volume concurrently to increase the field of view of the waveguide assembly, in a sample configuration.

FIGS. 10A and 10B are plots of the angle of propagation of light from the normal to the waveguide/air interface of the waveguide with a matched IC/OC waveguide using volume holographic gratings and the corresponding intensity of the light diffraction for simulation results using nine (9×) gratings multiplexed in angle for different portions of the image.

FIG. 11 is an isometric view of FIG. 7 illustrating the IC positioned at a single internal reflection of the light from the OC or within multiple internal reflections from the OC for 1-dimensional eye box expansion.

FIG. 12 is an illustration showing that re-interaction losses may occur when the light wave trapped by TIR is incident on the IC before reaching the portion of the waveguide between the IC and the OC or the portion of the waveguide including an interface with the OC.

FIG. 13 is a plot of the angle of incidence and diffraction of light on an IC using volume gratings and the corresponding intensity of the light where the incident angular ranges are shown inside the range that is trapped by TIR.

FIG. 14 is an illustration of a waveguide having a fold hologram that simultaneously folds and splits an input beam that is trapped by TIR but does not out-couple the light.

FIG. 15 is a plot of the angle of incidence and diffraction of light on the fold hologram of FIG. 14 using volume gratings and the corresponding intensity of the light diffraction showing the diffraction efficiency of 10× gratings multiplexed to achieve the fold hologram where 5× are used for the +y direction and 5× are used for the −y direction but no light is outcoupled.

FIG. 16 is an illustration of a waveguide assembly having a multiplexed volume hologram Splitter-Fold-OC (SFO) grating that combines the splitter, folding and output coupler function into one multiplexed volume hologram.

FIG. 17 is an illustration of a side view of a waveguide assembly implementing the SFO grating of FIG. 16 to outcouple light.

FIG. 18 is an illustration of a top view of a waveguide assembly implementing the SFO grating of FIG. 16 to outcouple light.

FIG. 19 is a plot of the angle of incidence and diffraction of light on the assembly of FIG. 16 and the corresponding intensity of the light diffraction showing the splitting and folding of the light by the SFO grating.

FIG. 20 is an illustration of a waveguide assembly having a multiplexed volume hologram fold grating (FOLD) layered with an Unfolding Output Coupler (UOC).

FIG. 21 is an illustration of a side view of the waveguide assembly including the UOC grating of FIG. 20 to outcouple light.

FIG. 22 is an illustration of a top view of the waveguide assembly including the UOC grating of FIG. 20 to outcouple light.

FIG. 23 is a plot of the angle of incidence and diffraction of light on the waveguide assembly of FIG. 20 having the fold grating and the corresponding intensity of the light diffraction showing the outputting of light by the multiplexed OCs of the layered on the fold grating.

FIG. 24 is an illustration of a waveguide assembly having a multiplexed volume hologram IC-Splitter-Fold (ICSF) grating with Unfolding Output Coupler (UOC).

FIG. 25 is an illustration of a side view of the waveguide assembly implementing the ICSF grating of FIG. 24 to incouple light.

FIG. 26 is an illustration of a top view of a waveguide assembly implementing the ICSF grating of FIG. 24 to incouple light.

FIG. 27 is a plot of the angle of incidence and diffraction of light on the waveguide assembly having the ICSF grating of FIG. 24 and the corresponding intensity of the light diffraction showing the outputting of light by the ICSF grating.

FIG. 28 is a plot of the angle of incidence and diffraction of light on the split and folded IC and the corresponding intensity of the light diffraction showing respective slivers of the field of view (FOV) by the respective UOCs of the ICSF grating of FIG. 24.

### DETAILED DESCRIPTION

Multiplexing of volume hologram couplers into a same volume increases the field of view of each of the components in a waveguide assembly such as an augmented reality (AR) waveguide assembly for use in electronic eyewear devices. The multiplexing can be done in any direction perpendicular to the optical axis. Multiplexing of the volume hologram couplers may be used to combine different functions of the AR waveguide assembly into one diffractive optical element (DOE) in the form of an input coupler or an output coupler. For example, each volume holographic grating of input couplers and output couplers has a different refraction angle, a different periodicity, or both relative to any other volume holographic grating in the same volume. The resulting DOEs reduce re-interaction losses, reduce thickness, reduce the amount of DOEs and the number of layers and airgaps, and increase robustness (volume versus surface relief that can scratch or break).

The devices described herein include DOEs in the form of input couplers, output couplers, and a waveguide assembly including one or more of such input couplers and output couplers. In sample configurations, the waveguide assembly includes a waveguide, an input coupler, and an output coupler. The waveguide propagates light at angles of incidence greater than a critical angle at which total internal reflection (TIR) occurs. The input coupler includes at least two gratings within a first three-dimensional (3D) volume. Each grating within the first 3D volume is responsive to input light of different wavelengths to reflect or transmit the input light into the waveguide as propagating light. Each grating within the first 3D volume has a same periodicity but a different orientation, a same orientation but a different periodicity, or both, to provide a different refractive index relative to each other grating within the first 3D volume. The output coupler similarly includes at least two gratings within a second 3D volume. Each grating within the second 3D volume is responsive to propagating light of different wavelengths propagating in the waveguide within an angle of incidence of the output coupler at which the propagating light is reflected or transmitted out of the waveguide. Each grating within the second 3D volume has a same periodicity but a different orientation, a same orientation but a different periodicity, or both, to provide a different refractive index relative to each other grating within the second 3D volume.

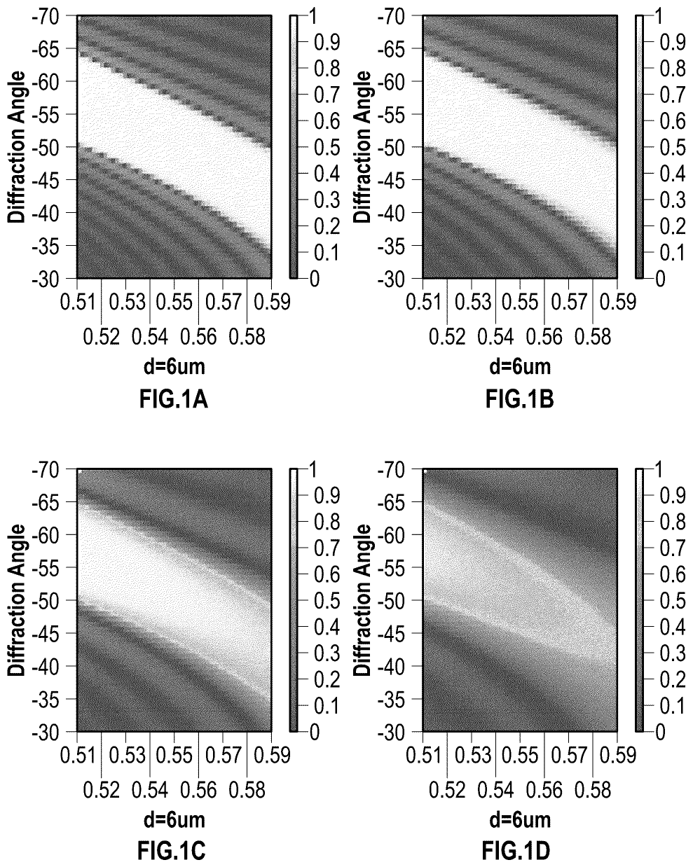

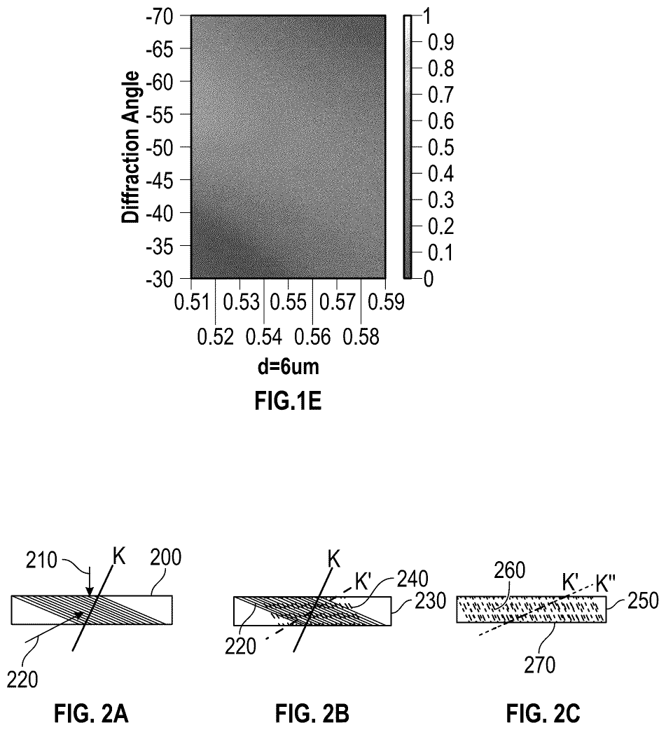

A detailed description will now be described with reference to FIGS. 1-28. Although this description provides a detailed description of possible implementations, it should be noted that these details are intended to be exemplary and in no way delimit the scope of the inventive subject matter.

DOEs operate by diffracting light. The design of the DOEs control the intensity and direction of the light as it interacts with structures sized on the order of the wavelength of light of interest.

Usually, light propagation occurs in isotropic media (vacuum, air, plastic, glass) where the dielectric constant and absorption constant are equal and constant regardless of the direction of the light wave. For purposes of this description, non-isotropic media is used for light propagation. More specifically, this description focuses on periodic variations of the dielectric constant (e.g., periodicity of the gratings) and, hence, of the refractive index in a volume.

The direction of the light as it is scattered by the periodic media (e.g., gratings) can be determined by finding the conditions in which the scattered waves add up in phase (constructive interference). A more complete solution is found by solving Maxwell's equations using a spatially dependent dielectric constant (intensity and direction). This condition can be satisfied by using integer multiples of the incident wavelength (or periodicity). As the thickness (interaction length of the incident light with the periodic structure) of a DOE increases, constructive interference is restricted to a narrower set of parameter conditions. When a DOE is considered thick, it is said to be operating in the Bragg regime where the diffraction efficiency is high and the diffraction is in a narrow band (i.e., incident angular/wavelength range for high diffraction efficiency is narrow).

FIGS. 1A-1E are graphs illustrating thickness (d) in microns versus diffraction angle for gratings showing that increasing thickness of a DOE increases the diffraction efficiency but reduces the bandwidth in angle and wavelength. In FIG. 1, the thickness varies from 6 microns (FIG. 1A) down to 3 microns (FIG. 1E). As illustrated, increasing thickness (from right to left in FIGS. 1A-1E) increases the diffraction efficiency but reduces the bandwidth in diffraction angle and wavelength. As used herein, diffraction efficiency is the performance of diffractive optical elements—especially diffraction gratings—in terms of power throughput. Diffraction efficiency is a measure of how much optical power is diffracted into a designated direction compared to the power incident onto the diffractive element.

The present disclosure focuses on Bragg-regime gratings. A volume or thick grating is defined as a periodic variation of the refractive index in a dielectric volume operating in the Bragg-regime. Note that a grating can be considered a hologram of light of a single wavelength (and hence the term holographic grating is used in the art).

Another characteristic of volume gratings is that several structures can be multiplexed (i.e., partially or completely overlap) in the same volume as appropriate to achieve the desired field of view. Multiplexing of volume gratings is described in more detail below with respect to FIG. 2. Light of multiple distinct wavelengths can be recorded in the same volume that will operate independently (within some limits). The volume gratings could be the same period structure but a different orientation (angle), same orientation but different period, or both.

FIGS. 2A-2C illustrate volume gratings in which several structures are multiplexed in the same volume yet operate independently. In FIG. 2A, incident plane waves/light rays 210 interact with the interference pattern 220 of the volume grating 200 to produce diffracted light represented by a vector K that is perpendicular to the interference pattern 220 of the volume grating 200. FIG. 2B illustrates a volume grating 230 having two different interference patterns 220 and 240 at different angles multiplexed within the same volume. The volume grating 230 thus diffracts incident plane waves/light rays 210 to produce diffracted light represented by vectors K and K′ that are perpendicular to the respective interference patterns 220 and 240. In FIG. 2C, the volume grating 250 has two different multiplexed interference patterns 260 and 270 that have different lengths (periodicities) but the same orientations, thus producing diffracted light represented by vectors K′ and K″ in response to incident plane waves/light rays 210.

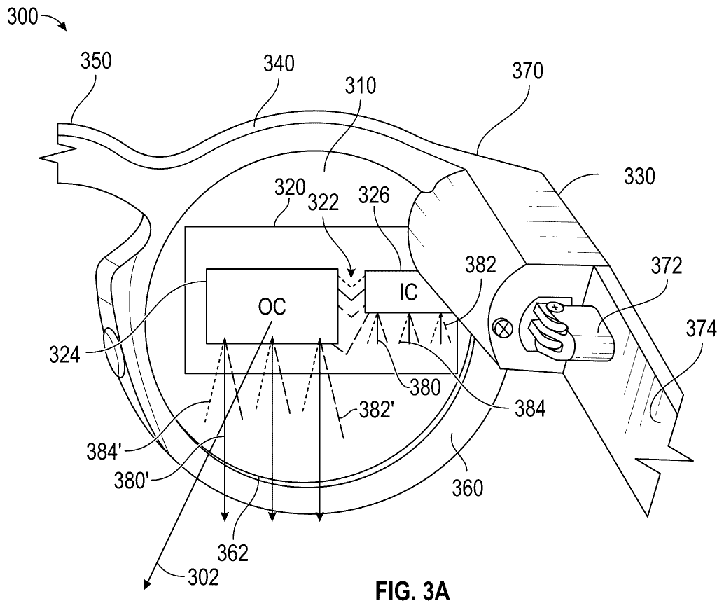

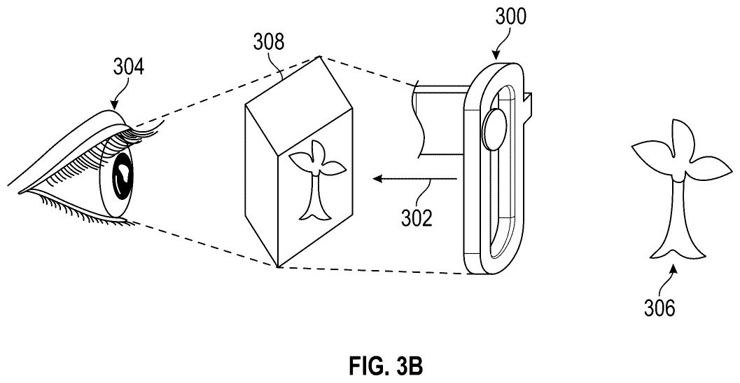

Since the direction of the diffracted light can be controlled with the periodicity of the media, DOEs may be used in Augmented Reality (AR) glasses as a means to trap light by TIR in a piece of glass or plastic (waveguide) and force it out at a desired position (e.g., in front of the eyes of the user). FIG. 3A illustrates a DOE used in Augmented Reality (AR) glasses 300 for trapping light in a waveguide by TIR and forcing the light out at a desired position, such as along optical axis 302 directed out of the page to the eyes of the user. For example, as shown in FIG. 3B, the AR glasses 300 may force light out along optical axis 302 towards the eye 304 of the user. As illustrated, a real or AR image 306 is presented to the user's eye 304 in an eye box 308, which is the three-dimensional space within which the user may see the entire image 306 without moving her head or making any other adjustment of her eye 304.

FIG. 3A illustrates a rear view of the right optical assembly 310 of an example hardware configuration of an electronic eyewear device 300. The right optical assembly 310 includes a waveguide assembly 320 that includes a waveguide 322 and at least one of an output coupler 324 positioned in front of the eye 304 of the wearer and an input coupler 326 that is typically located on a side edge of the right optical assembly 310. The electronic eyewear device 300 can take other forms and may incorporate other types of frameworks, for example, a headgear, a headset, or a helmet.

Electronic eyewear device 300 may include multiple visible light cameras that form a stereo camera, of which the right visible light camera (not shown) is located on a right temple 330 and the left visible light camera (not shown) is located on a left temple. As illustrated in FIG. 3A, the electronic eyewear device 300 includes a frame 340, a bridge 350, a right rim 360 including aperture 362 that holds the right optical assembly 310, a right temple 330 extending from a right lateral side 370 of the frame 340, and a see-through image display in the right optical assembly 310 including the waveguide assembly 320 having the output coupler 324 that, for example, presents a graphical user interface to a user's eye 304 in the eye box 308. A right hinge 372 connects the right temple 330 to hinged arm 374 of the electronic eyewear device 300. Corresponding elements may be found on the left side of the electronic eyewear device 300. During operation, the right visible light camera connected to the frame 340 or the right temple 330 captures simultaneously with the left visible light camera respective images of the scene which partially overlap. The captures images may be input into the waveguide assembly 320 as an image source for the optical assembly 310. Although not shown in FIG. 3A, a processor is coupled to the electronic eyewear device 300 and connected to the visible light cameras and a memory accessible to the processor within the electronic eyewear device 300 itself.

In the right optical assembly 310 of FIG. 3A, the input coupler (IC) 326 is a DOE that diffracts the incident light 380, 382, 384 at angles inside the waveguide 322 that are totally internally reflected and hence trapped. Since the light is not able to be transmitted outside of the waveguide 322, all the light is propagated by the waveguide 322 until the propagation angle θ is changed by the output coupler (OC) 324. The OC 324 diffracts light that is incident at the angle θ (which is greater than the critical angle at which the light would escape the waveguide 322 and hence trapped by TIR) and the diffracted light 380′, 382′, 384′ exits out of the waveguide assembly 320 toward the eye 304 of the wearer. As known to those skilled in the art, the critical angle θ c is determined by Snell's Law from the refractive indices of the materials between two interfaces. In this example, the waveguide/air interface is of interest.

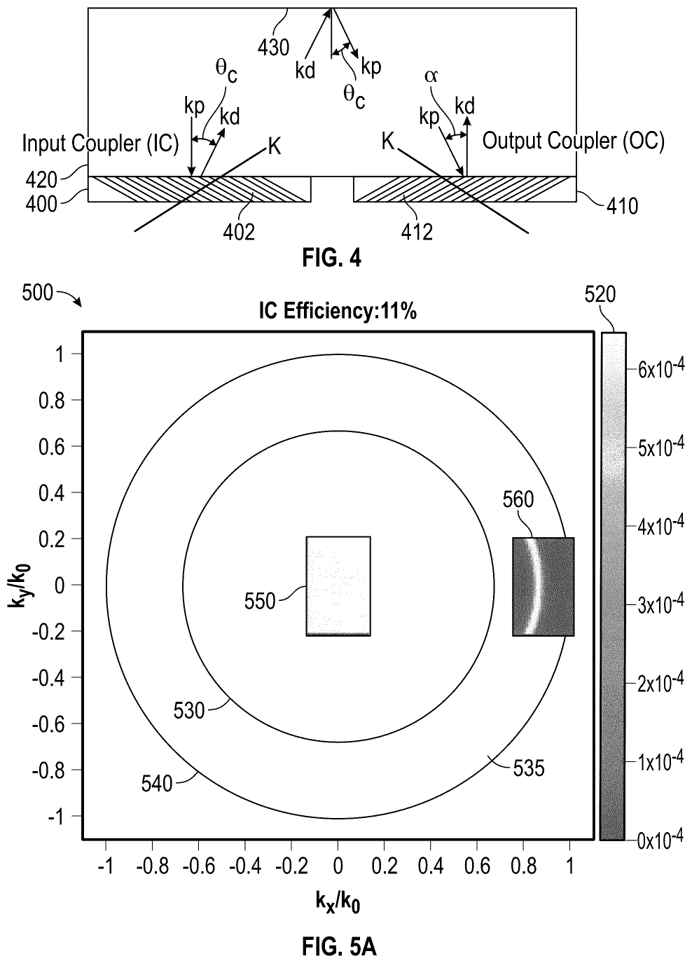

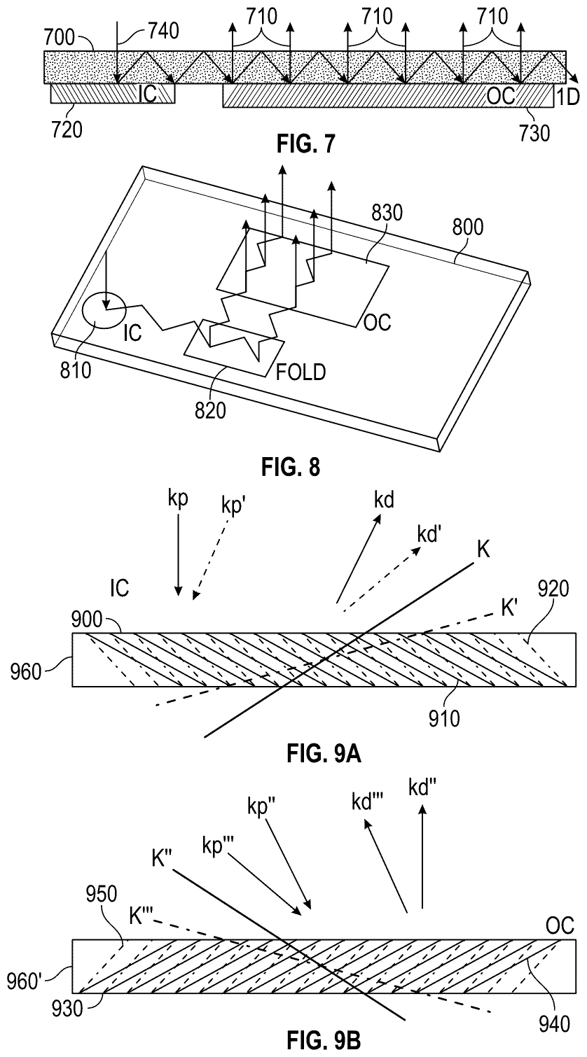

FIG. 4 illustrates a matched input coupler (IC) 400 and output coupler (OC) 410 having respective volume gratings 402 and 412 whereby light incident on the IC 400 (kp) is reflected by the air-waveguide interface 430 via TIR (center-top) and incident on the OC 410 in reflection mode. The light kd is diffracted by the IC 400 or the OC 410 and is incident on the air-waveguide interface 430 (center-top). When the diffraction of light kd is at an angle θ larger than the critical angle θ c at which the light would escape the waveguide 420, the light kd is trapped in the waveguide 420 by TIR at the interface 430. The IC 400 is matched to the OC 410 if it outputs light at an angle within the acceptance angle range of the OC 410, where the minimum acceptance angle is the maximum incident angle at which an optical element or material will trap light by TIR. At the diffraction angle θ (where θ is greater than the critical angle θ c), the light is trapped in the waveguide 420 by TIR until it changes direction at the OC 410 (e.g., see FIG. 7). When the light trapped by TIR is incident at the OC 410, the light is diffracted at an angle α (FIG. 4) that escapes the waveguide 420 since α is smaller than the critical angle.

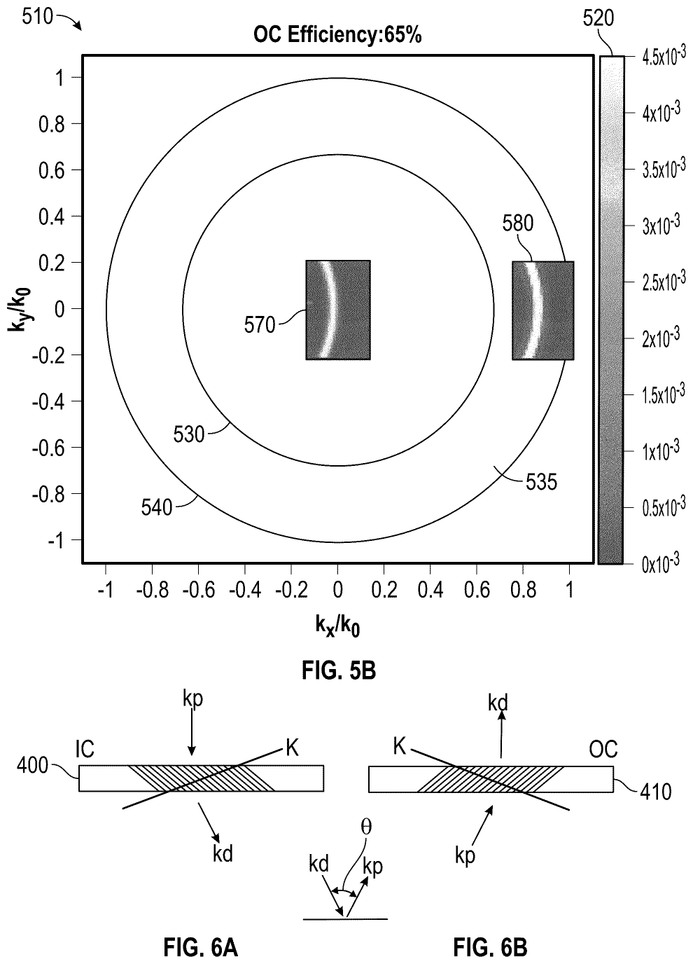

FIGS. 5A and 5B are plots 500 and 510, respectively, of the angle of incidence and diffraction of light on a matched IC/OC waveguide assembly 320 using single volume holographic gratings and the corresponding intensity of the light diffraction. In FIGS. 5A and 5B, the x-y plane represents the angle of incidence on the waveguide/air interface. The bar 520 on the right of each plot indicates the intensity of the light. Any light inside the smaller circle 530 is propagating at an angle smaller than the critical angle and hence is not trapped by TIR. Any light outside of the outer circle 540 represents an angle larger than 90 degrees where propagation is not possible. Light in the “donut” 535 between the concentric circles 530 and 540 is incident on the interface between critical and 90 degrees, and hence is trapped by TIR. In these plots, the “donut” 535 between inner circle 530 and outer circle 540 represents propagation angles at which the light is trapped by TIR. Increasing the size of the “donut” 535 increases the field of view (FOV) that the waveguide can sustain.

FIG. 5A shows the effect of the interaction by IC 400 with the light where light from a source with a flat (in angle) diffraction intensity profile is represented by the intense rectangle 550 in the center. Possible diffraction is represented by the rectangle 560 on the right. Given that a single volume grating is represented in FIG. 5A, the performance is highly efficient for a very narrow range of angles (at or close to Bragg) and hence the overall diffraction efficiency as illustrated by the rectangle 560 is low. Parts of the source that are outside of that range are lost, making the field of view of the image very narrow. FIG. 5B shows the effect of the interaction by OC 410 with the light where propagating light in the waveguide is diffracted by the OC 410 at a different diffraction angle back to the same angular range of the source 570 as shown at 580.

The description of FIGS. 4 and 5 above is based on reflection-mode diffraction. In this case, both incident and diffracted beams are on the same side of the air-waveguide interface. It is possible to realize this IC-OC matching in transmission mode of the matched IC and OC of FIG. 4 as shown in FIGS. 6A and 6B. As shown in FIG. 6A, in the transmission mode, the light incident on the IC 400 (kp) is transmitted through the IC 400 as diffracted light (kd). Similarly, as shown in FIG. 6B, in the transmission mode, the light incident on the OC 410 (kp) is transmitted through the OC 410 as diffracted light (kd).

Given that a system that creates a single image in a specific place would be very limited (i.e., the user's eye would have to be precisely in one place or risk not seeing the image at all), multiple internal reflections of the light in the waveguide at the interface with the OC 410 may be used to create many images to expand the eye box 308. FIG. 7 is a simplified diagram illustrating a waveguide 700 where each arrow 710 pointing up represents a single input image 740 that is input at the IC 720, reflected within the waveguide 700, and is output from the waveguide 700 at 710 every time the light wave trapped by TIR interacts with the OC 730. The light escapes at 710 due to diffraction of the light by the OC 730 to an angle that is less than the critical angle. This is achieved by controlling the diffraction efficiency of each interaction with the waveguide/OC interface. Typically, the amplitude of the modulation of the refractive index is a function of x and/or y, so the first interaction encounters a refractive index modulation that has the same period but is “weaker.” Towards the end of the interactions, the period is the same but the modulation is much “stronger.” In FIG. 7, reflection-mode diffraction is illustrated; however, it will be appreciated that transmission mode diffraction may also be used as it is possible to mix and match reflection and transmission modes (e.g., reflection IC with transmission OC or vice versa). In the latter case, the user's eyes would be on the opposite side of the waveguide 700.

The use of diffraction of a light wave trapped by TIR is not limited to extracting the light as diffraction also may be used to change the angle of the light wave trapped by TIR to another angle that is greater than the critical angle and thus remains trapped by TIR. For example, gratings also can be used to redirect the propagating direction of a light wave by 90° (e.g., a light wave trapped by TIR may be redirected from on-plane (on the page and propagating left-to-right within the waveguide as shown in FIG. 7) to out-of-plane (out of the page and propagating towards/away from the reader)). The gratings that perform these operations are called fold gratings and are shown in FIG. 8. As illustrated, the waveguide 800 receives light input at IC 810 and the incident light passes through fold grating 820 to cause the light to propagate in the direction in angular ranges into the page or out of the page at the OC 830. It will be appreciated that fold gratings 820 may be used to provide two-dimensional pupil expansion for the eye box 308.

Broad angle and broad-spectrum performance are needed to realize an AR device since large angular full-color images are desired by the user. The configurations described below address these needs in the art by operating within the Bragg regime whereby the conditions for non-negligible diffraction are broad.

As noted above, multiplexing of volume hologram couplers (with multiple gratings) into a same volume may be used to address these needs in the art by increasing the eye box 308 (FIG. 3B) for a waveguide assembly of the type that may be included in AR enabled electronic eyewear 300 as shown in FIG. 3A. The multiplexing can be done in any direction perpendicular to the optical axis 302 for high diffraction efficiency. Also, multiplexing of the volume hologram couplers may be used to combine different functions of the waveguide assembly of AR enabled electronic eyewear 300 into one DOE in the form of an input coupler with a fold, an output coupler with a fold, or separate folding directions combined into one device where the light is directed toward the user's eye 304 as shown in FIG. 3B. Any number of gratings (greater than one) can be multiplexed into a volume. The resulting DOEs reduce re-interaction losses, reduce thickness, reduce the amount of DOEs and the number of layers and airgaps, and increase robustness (volume versus surface relief that can scratch or break).

FIGS. 9A and 9B respectively illustrate IC 900 with volume gratings 910 and 920 and OC 930 with volume gratings 940 and 950 that use multiplexing to allow multiple gratings to occupy the same volume concurrently to increase the field of view of the corresponding waveguide assembly 320. Although FIGS. 9A and 9B illustrate two interference patterns as an example, it will be appreciated that more than two interference patterns k₁ through kₙ may be provided in the IC 900 and/or the OC 930. In FIG. 9A, incident light kp and kp′ (e.g., from a display driver of the electronic eyewear device 300 (FIG. 3A) equipped with a waveguide assembly 320 as described herein) at respective wavelengths are provided to the IC 900 at different angles and diffracted by the respective volume gratings 910 and 920 having different multiplexed interference patterns at angles represented by vectors K and K′ so as to change the direction of the incident light to produce light at angles kd and kd′. On the other hand, in FIG. 9B, incident light kp″ and kp′″ provided to the OC 930 at different angles is reflected by the respective volume gratings 940 and 950 having different multiplexed interference patterns at angles represented by vectors K″ and K′″ so as to change the direction of the incident light to produce light at angles kd″ and kd.′″ As shown in FIG. 9A, the gratings 910 and 920 occupy the same volume 960 concurrently, while as shown in FIG. 9B, the gratings 940 and 950 occupy the same volume 960′ concurrently. Such configurations reduce the number of layers necessary and hence reducing the overall thickness of the DOEs 900, 930 by requiring less layers, less separate DOEs, and eliminating the need for airgaps in-between these layers. Since the respective volume gratings 910, 920 and 940, 950 are inside the volume 960 and not a surface relief feature surrounded by air, the DOEs 900, 930 are inherently less prone to breaking, thus increasing robustness.

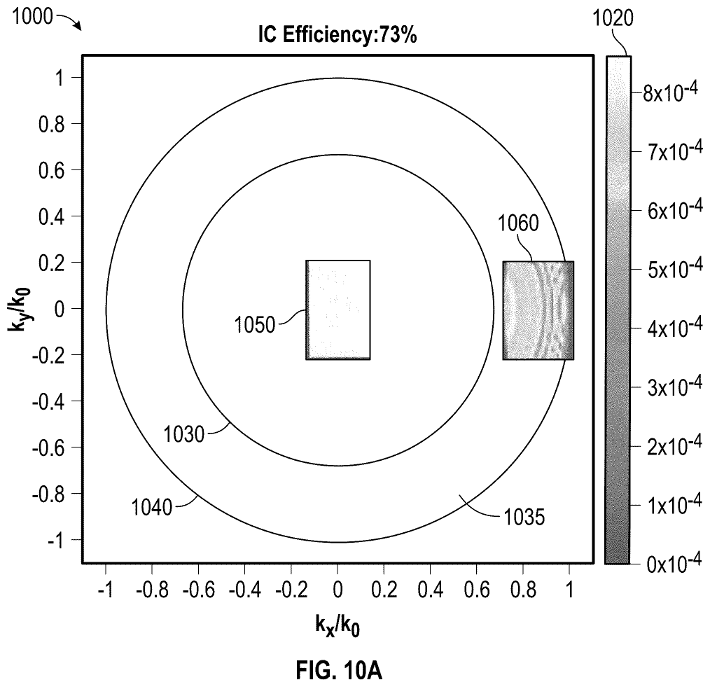

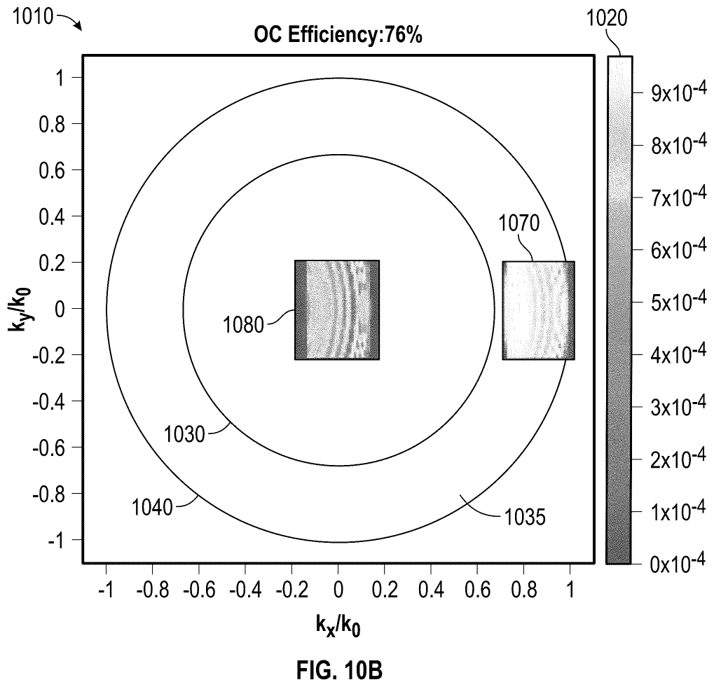

FIG. 10A is a plot 1000 of the angle of propagation of light from the normal to the waveguide/air interface of the waveguide. The “donut” 1035 between inner circle 1030 and outer circle 1040 represents propagation angles at which the light is trapped by TIR. Increasing the size of the “donut” 1035 increases the field of view (FOV) that the waveguide can sustain. Incident light 1050 is diffracted into TIR trapped light 1060 using an IC 900 including volume multiplexed holographic gratings. The corresponding intensity of the light diffraction for simulation results using nine 9× gratings multiplexed in angle for different angular portions of the image are shown in FIG. 10B. FIG. 10B is a plot 1010 of the angle of incidence 1070 and diffraction 1080 of light on the OC 930 using multiplexed volume holographic gratings. The corresponding intensity of the light diffraction for simulation results using nine 9× gratings multiplexed in angle for different angular portions of the image are shown in FIG. 10B. The bar 1020 on the right of each plot represents the intensity of the incident and diffracted light. Increasing the size of the “donut” 1035 increases the FOV that the waveguide can sustain. In the simulation results of FIGS. 10A and 10B, it can be seen that the FOV of the system has been greatly increased when compared to FIG. 5A and FIG. 5B.

FIG. 10A shows the effect of interaction of IC 900 with the light from a rectangularly-shaped source with a flat diffraction intensity profile represented by the intense rectangle 1050 in the center. Possible diffraction is represented by the rectangle 1060 on the right. The performance is optically efficient for a greater range of angles for a particular FOV when compared to FIGS. 5A and 5B. Similarly, FIG. 10B shows the effect of the interaction of OC 930 with the light 1070 diffracted by the IC 900. It will be appreciated that light 1060 and light 1070 are essentially the same light except that light 1060 got TIR-trapped and propagated down the waveguide until it reached the OC 930 as light 1070.

The light diffracted by the OC 930 is shown at 1080. Once again, the performance is optically efficient for a greater range of angles for a particular FOV.

The IC 900 of FIG. 9A can be adapted to enable pupil expansion by not diffracting all the input light after the first interaction with the OC 930. For example, the efficiency of each outcoupling may increase to keep the power output the same for each “pupil.” The eye may be located at the edge of the eyebox so as to only see the last two diffracted beams. If the diffraction efficiency were 100% at the first interaction, 100% of the light would exit and none would reach the eye at the edge of the eyebox.

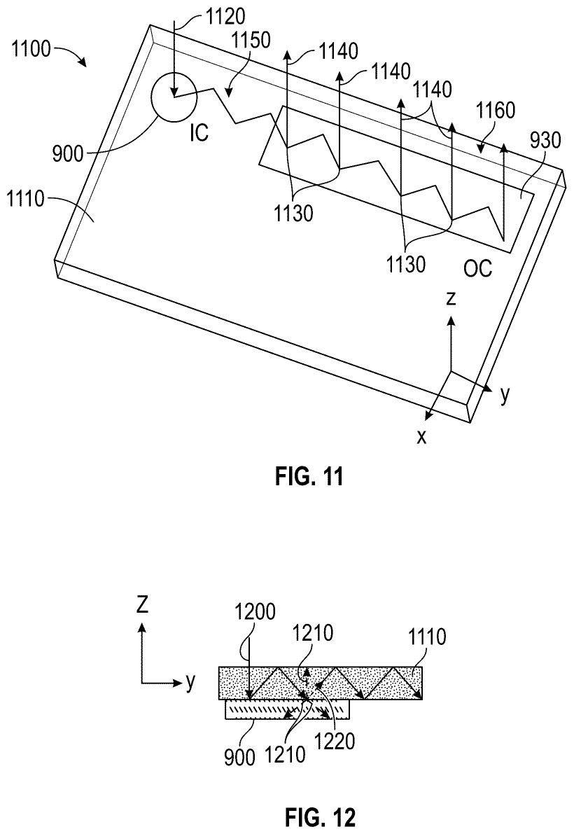

A 1-dimensional eye box expansion in the form of a waveguide assembly 1100 is shown in FIG. 11. As used herein, a waveguide assembly 1100 may include multiple waveguide junctions connecting waveguides 1110. The waveguide junctions may include at least one of IC 900 or OC 930 of the type described herein.

As shown in FIG. 11, the OC 930 has a length in the propagation direction of the light within the waveguide 1110 that is orthogonal to the light 1120 input into the IC 900 (in this example in the y direction) whereby the propagating light interacts with the OC 930 multiple (at least two) times in the propagation direction. It will be appreciated that the interface between the IC 900 or the OC 930 and the waveguide 1110 is assumed to be lossless. Light interacts with either the IC 900 or the waveguide-air interface (either TIR-trapped after the IC 900 or out-coupled after interacting with the OC 930) or with the OC 930. The light is diffracted by the OC 930 to an angle less than the critical angle to escape the waveguide 1110 as respective images 1140 that provide 1-dimensional eye box expansion in the propagation direction (y-direction). In sample configurations, OC 930 may have a diffraction efficiency profile as a function of length that is adapted to control an intensity of the output light 1140 whereby the light 1140 output by the OC 930 has a desired diffraction intensity profile along the length of the OC 930 in the propagation direction. For example, the diffraction efficiency profile of the OC 930 may be selected whereby each output light wave 1140 that escapes the waveguide 1110 has approximately the same intensity to thereby provide a consistent intensity along the length of the OC 930 and hence the eyebox.

An advantage of such configurations over surface relief gratings (SRGs) is reduced re-interaction losses. Re-interaction losses occur when the light wave trapped by TIR is incident on the IC 900 before reaching the portion 1150 of the waveguide 1110 between the IC 900 and OC 930 or the portion 1160 of the waveguide 1110 including the interface 1130 with the OC 930. In this case, there are possible diffraction conditions (non-Bragg) that could diffract the light wave out of the waveguide 1110.

FIG. 12 illustrates that re-interaction losses may occur when the incident light wave 1200 trapped by TIR is incident on the IC 900 before reaching the portion 1150 of the waveguide 1110 between the IC 900 and OC 930 or the portion 1160 of the waveguide 1110 including the interface 1130 with the OC 930. As shown in FIG. 12, the incident light waves 1200 may include possible diffractions from the IC 900 that diffract the input light 1200 to an angle that is less than the critical angle, thus allowing the input light 1200 to escape the waveguide 1110 before it reaches the OC 930. Such light waves 1210 are undesired anywhere in the waveguide assembly 1100 except at the OC 930. On the other hand, the desired light wave 1220 may be diffracted by the IC 900 to an angle that is greater than the critical angle, thus trapping the light wave 1210 by TIR. Since the undesired diffractions of the light waves 1200 at the IC 900 are not in Bragg (outside of the range where the IC 900 is diffraction efficient), the re-interaction loss is minimized.

In the configuration of FIG. 12, at least one of the volume gratings may diffract the light wave trapped by TIR at the IC 900 so as to reduce re-interaction losses incurred when the light wave trapped by TIR interacts with the IC 900 (e.g., reflects light wave 1220 at an angle of incidence greater than the critical angle to trap the light wave 1220 by TIR rather than allowing diffracted light waves 1210 to escape).

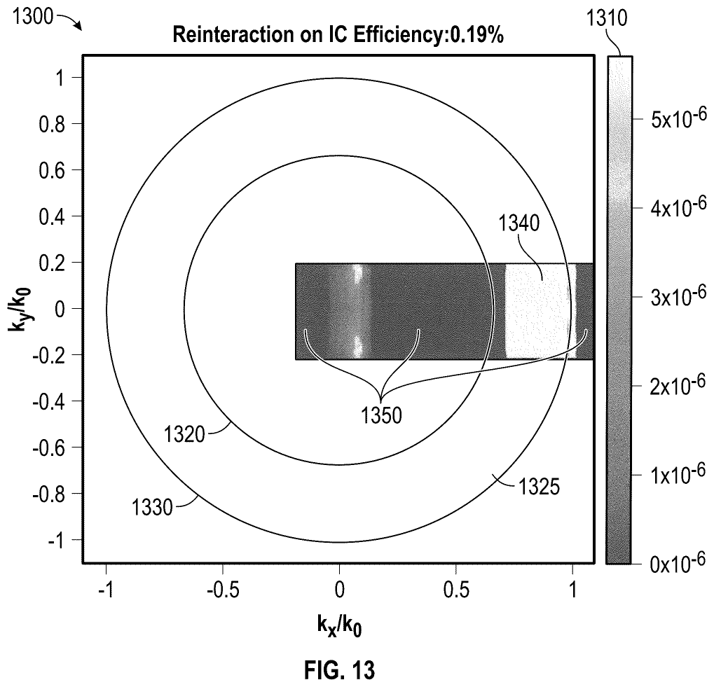

This can be seen in the simulation of re-interaction loss shown in FIG. 13. FIG. 13 is a plot 1300 of the angle of incidence and diffraction of light on an IC 900 using volume gratings and the corresponding intensity of the light where the incident angular ranges are shown inside the range that is trapped by TIR. The diffracted angular ranges and intensities correspond to the reinteraction loses. Plot 1300 shows the effects of re-interaction on IC diffraction efficiency, where the bar 1310 on the right indicates the intensity of the light. In plot 1300, the “donut” 1325 between inner circle 1320 and outer circle 1330 represents the field of view (FOV). In FIG. 13, the incident angular ranges (originally diffracted by the multiplexed IC 900 as light waves 1200 in FIG. 12) are shown as highly efficient for the intensity versus angle incident light marked at 1340, inside the range that is trapped by TIR. However, the diffraction 1350 from the re-interaction for the escaping light is shown to have very low diffraction efficiency.

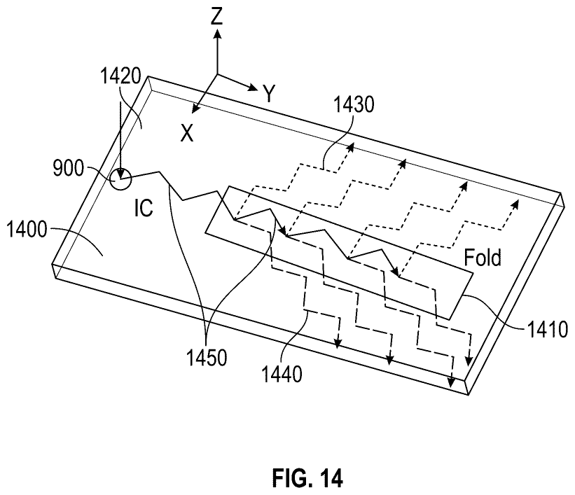

FIG. 14 illustrates a waveguide assembly 1400 including a fold hologram 1410 that simultaneously folds and splits an input light beam that is trapped in the waveguide 1420 by TIR but does not out-couple the light. The fold hologram includes two or more fold gratings (e.g., fold gratings 820 from FIG. 8), multiplexed in the same volume so as to change the direction of part of the in-coupled light 1450 by IC 900 in angles about the z axis. As shown in the sample geometry in FIG. 14, the light wave trapped in the waveguide 1420 by the IC 900 is split into light waves 1430 and 1440 by fold hologram (with two volumetric fold gratings) 1410 and the light waves 1430 and 1440 are turned around the z axis on the x-y plane. The light waves 1430 and 1440 thus propagate in the +y,+x and −y,−x planes, respectively. The fold hologram 1410 of FIG. 14 need not be part of the IC 900 or the OC 930 but may be a separate light-turning device adapted to fold and split the light beam trapped within the waveguide 1420 by TIR. In this example, the fold hologram 1410 outputs light waves 1430 and 1440 that have been diffracted at different angles and trapped in the waveguide 1420 by TIR but at different angles than the input light waves received by the fold hologram 1410. In sample configurations, the fold hologram 1410 has a diffraction efficiency selected to control an intensity of each of the two split light waves 1430 and 1440 output by the fold hologram 1410. Also, the fold hologram 1410 may be configured such that an incident light wave received by the fold hologram 1410 is matched to an output light wave of the IC 900 and the two light waves output by the fold hologram 1410 are in turn matched to an input of the OC 930.

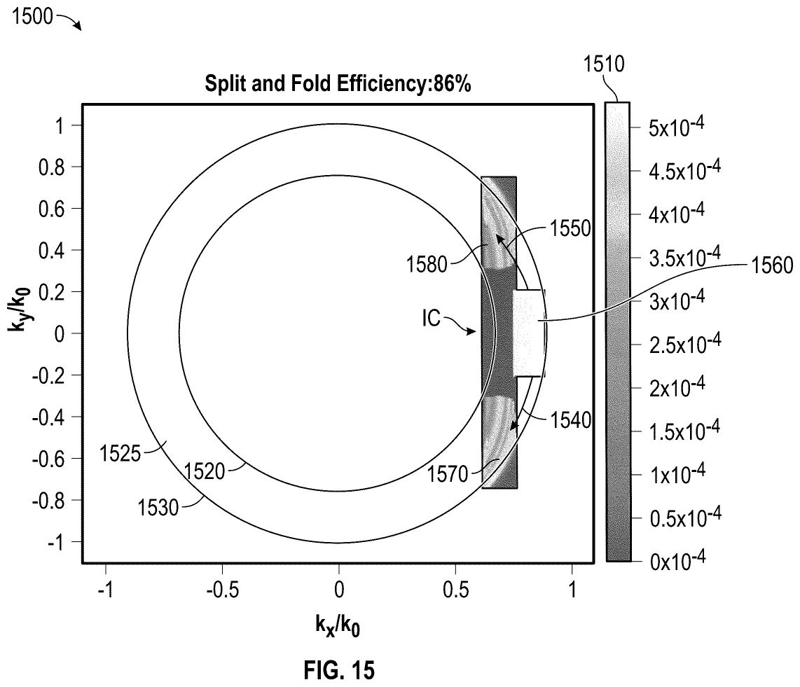

FIG. 15 is a plot 1500 of the angle of incidence and diffraction of light on the fold hologram 1410 of FIG. 14 and the corresponding intensity of the light diffraction showing the efficiency of 10× gratings multiplexed to achieve the fold hologram 1410. Plot 1500 shows the split and fold efficiency, where the bar 1510 on the right indicates the intensity of the light. In plot 1500, the “donut” 1525 between inner circle 1520 and outer circle 1530 represents the field of view (FOV). As shown in plot 1500, 5× gratings are used for the +y direction (arrow 1540) and 5× gratings are used for the −y direction (arrow 1550). It is noted that the simulated efficiency of 86% for the incident light 1560 includes both diffracted light waves (i.e., 43% in the +y angular ranges 1570 and 43% in the −y angular ranges 1580). It can also be seen that this configuration does not outcouple the light (i.e., no intensity is shown in the inner circle 1520).

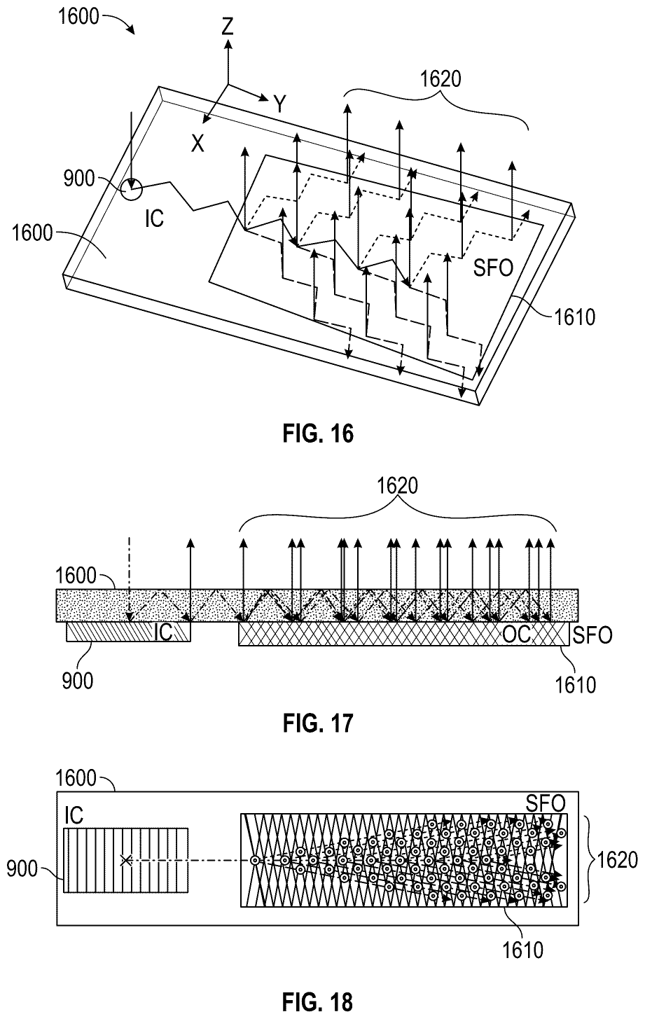

FIG. 16 illustrates a waveguide assembly 1600 having a multiplexed volume hologram Splitter-Fold-OC (SFO) 1610 that combines the splitter, folding and output coupler functions of the gratings of FIGS. 11 and 14 into one multiplexed volume hologram. In this configuration, each SFO 1610 may have a diffraction efficiency selected to control an intensity of the outcoupled light 1620 of each of the two split and fold light as well as the out coupled waves output by the SFO grating 1610. In this example configuration, light waves trapped in the waveguide 1600 by the IC 900 are split into three waves: one folded into the +x,+y direction, one folded into the −x,+y direction, and one outcoupled 1620.

FIG. 17 illustrates a side view of the waveguide assembly 1600 implementing the SFO grating 1610 of FIG. 16 to outcouple light at 1620. FIG. 18 illustrates a top view of the waveguide assembly 1600 implementing the SFO grating 1610 of FIG. 16.

In FIG. 18, the outcoupled light 1620 extends out of the page along the z axis. It will be appreciated that the outcoupled light 1620 extends the eye box 308 in the x and y directions.

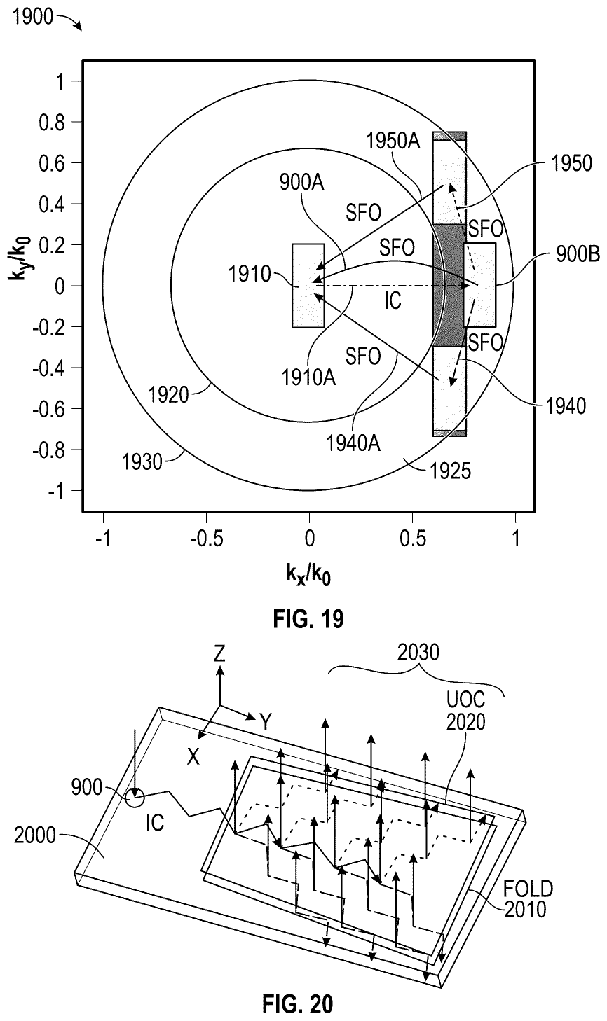

FIG. 19 is a plot 1900 of the angle of propagation of light from the normal to the waveguide assembly 1600 of FIG. 16 showing the TIR trapping at 1910A of the incident light 1910 by the IC 900, the folding 1940 into the +x,+y direction and the folding 1950 into the −x,+y direction by the SFO grating 1610, and the outcoupling 1950A from the +x,+y direction, the outcoupling 1940A from the −x,+y direction and the outcoupling 900A from the on-axis direction. In plot 1900, the “donut” 1925 between inner circle 1920 and outer circle 1930 represents propagation angles at which the light is trapped by TIR. As shown, the incident light 1910 is split by the SFO 1610 into diffracted light waves 1940 and 1950 that are highly diffraction efficient. The respective diffracted light waves 1940 and 1950 may be diffracted back out of the waveguide assembly 1600 as shown.

FIG. 20 illustrates a waveguide assembly 2000 including a multiplexed volume hologram Fold grating (FOLD) 2010 layered with an Unfolding Output Coupler (UOC) 2020 that layers the FOLD grating 2010 and the configuration of the IC 900 described above. In this case, the IC 900 and the FOLD grating 2010 operate as described above with respect to FIG. 14. However, in sample configurations, the IC 900 and the FOLD grating 2010 are disposed in a first layer of the waveguide assembly 2000 and the UOC 2020 is disposed in a second layer of the waveguide assembly 2000, the second layer being different from the first layer. As also illustrated, the UOC 2020 outcouples the light 2030 as it interacts with the FOLD grating 2010.

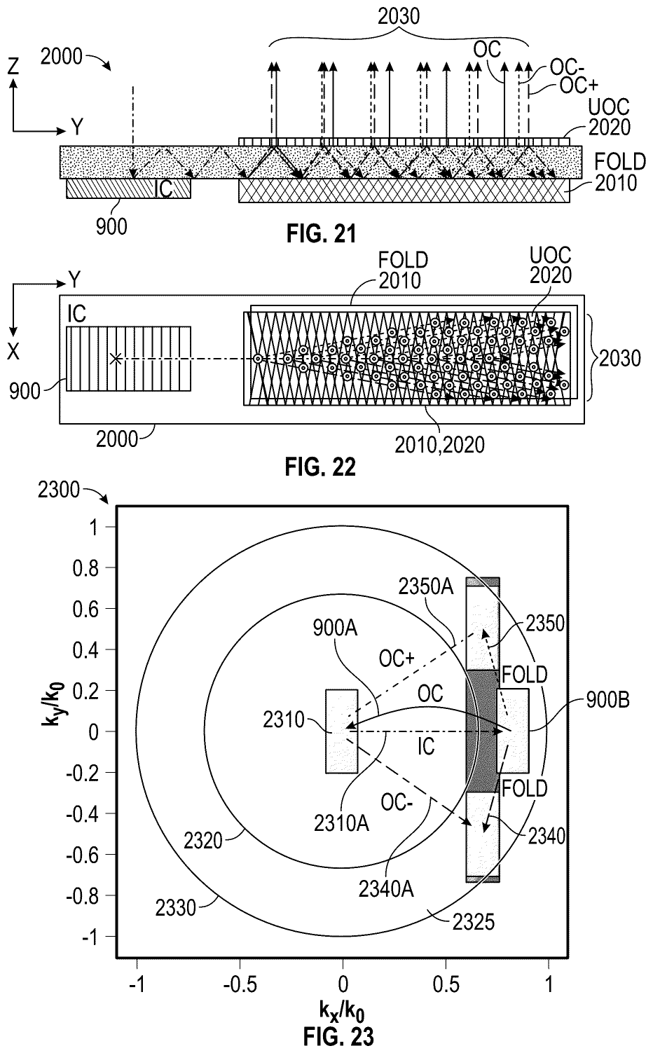

FIG. 21 illustrates a side view of the waveguide assembly 2000 of FIG. 20 including the FOLD grating 2010 to split and fold the light and the UOC 2020 to outcouple the light 2030. FIG. 22 illustrates a top view of the waveguide assembly 2000 of FIG. 20. As illustrated, the UOC 2020 includes three (3×) multiplexed OCs 930, each matched to a different propagation direction in the x-y plane: the light folded at 1430 and 1440 and the light in-coupled at 900B by the IC 900. The UOC 2020 out-couples the remaining light (OC) on the y axis (directly from the IC 900), while OC+ and OC− outcouple the light folded by the FOLD grating 2010 in each oblique direction at 2030.

In FIG. 22, the outcoupled light 2030 extends out of the page along the z axis. It will be appreciated that the outcoupled light 2030 extends the eye box 308 in the x and y directions.

FIG. 23 is a plot 2300 of the angle of propagation of light from the normal to the waveguide/air interface of the waveguide assembly 2000 including the FOLD grating 2010 and the corresponding intensity of the light diffraction showing the outputting of light by the UOC 2020 of FIG. 20. Incident light 2310 is trapped by IC 900 into the 2310A direction. The trapped light 900B is folded by the FOLD hologram 2010 into the +x,+y direction 2350 and the −x,+y direction 2340. The UOC 2020 outcouples part of the 900B light into the 900A direction and all the folded light 2350, 2340 in into the 2350A and 2340A directions, respectively. In plot 2300, the “donut” 2325 between inner circle 2320 and outer circle 2330 represents propagation angles at which the light is trapped by TIR. As shown, the incident light 2310 is split and folded by the UOC 2020 into diffracted light waves 2340 and 2350 that are highly diffraction efficient. The respective diffracted light waves 2340 and 2350 and the remaining original light 900B may be out-coupled as OC, OC+ and OC− for each oblique direction as shown.

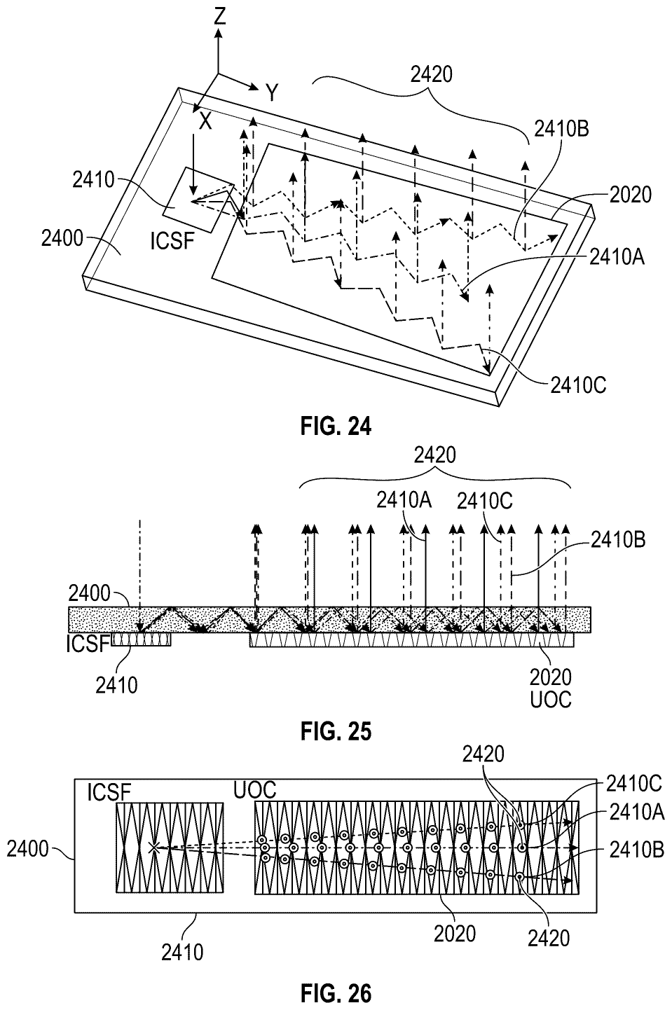

FIG. 24 illustrates a waveguide assembly 2400 having a multiplexed volume hologram IC-Splitter-Fold (ICSF) grating 2410 with Unfolding Output Coupler (UOC) 2020 in reflection mode. This configuration multiplexes the in-coupling, splitting and folding functions into the input coupler (ICSF grating 2410). The UOC 2020 is matched to out-couple the light at 2420 from the respective on-axis and oblique directions 2410A, 2410B, and 2410C. In this sample configuration, the ICSF 2410 includes an IC 900 multiplexed with two more ICs 900 at oblique directions at angles about the z axis corresponding to propagation directions on-axis 2410A and oblique in 2410B and 2410C.

FIG. 25 illustrates a side view of the waveguide assembly 2400 implementing the ICSF grating 2410 of FIG. 24 to incouple light. FIG. 26 illustrates a top view of the waveguide assembly 2400 of FIG. 24. The UOC 2020 includes three (3×) multiplexed ICs, each matched to a different propagation direction in the x-y plane. The UOC 2020 out-couples the remaining light (UOC) for each oblique direction (2410A, 2410B, 2410C) at 2420 from the ICSF grating 2410.

In FIG. 26, the outcoupled light 2420 extends out of the page along the z axis. It will be appreciated that the outcoupled light 2420 extends the eye box 308 in the x and y directions.

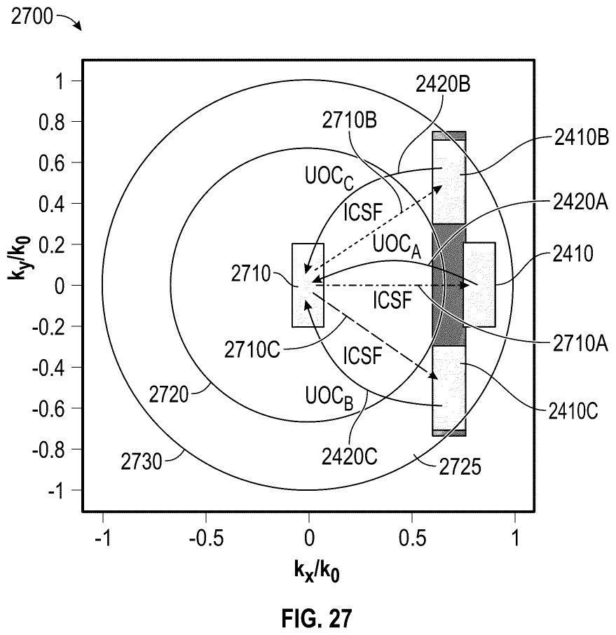

FIG. 27 is a plot 2700 of the angle of propagation of light from the normal to the waveguide assembly 2400 including the ICSF grating 2410 showing the input light 2710, TIR trapping of light into one on-axis 2710A, and two oblique propagation directions 2710B and 2710C by the ICSF grating 2410 of FIG. 24. In plot 2700, the “donut” 2725 between inner circle 2720 and outer circle 2730 represents propagation angles at which the light is trapped by TIR. As shown, the incident light 2710 is diffracted on axis 2710A, and obliquely at 2710B and 2710C by the ICSF 2410 into three trapped propagation directions (on-axis 2410A, oblique 2410B and 2410C) that are equally efficient. The respective diffracted light waves 2410A 2410B and 2410C may be out-coupled by the UOC 2020 diffraction 2420A, 2420B and 2420C for each on-axis and oblique direction as shown.

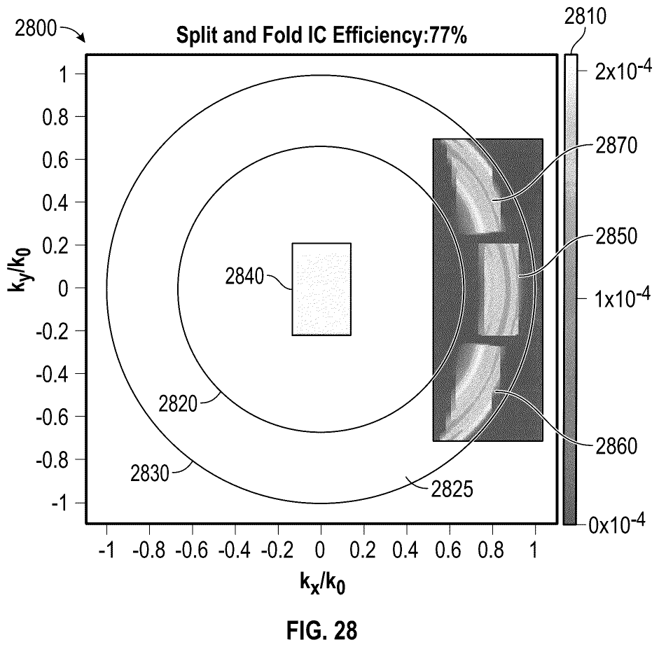

FIG. 28 is a plot 2800 of the simulation results of the angle of propagation of light from the waveguide assembly 2400 including only ICSF grating 2410. The bar 2810 on the right indicates the intensity of the light. In plot 2800, the “donut” 2825 between inner circle 2820 and outer circle 2830 represents propagation angles at which the light is trapped by TIR. Each IC 900 has 7× gratings to increase the FOV. This can be seen in the sliver-like appearance of the intensity profile. Incident light propagation 2840 is diffracted by each IC 900 of the ICSF grating 2410 into propagation directions 2850, 2860 and 2870.

While the multiplexed volume hologram couplers described herein have been described for use in augmented reality waveguides, it will be appreciated the use of the multiplexed volume hologram couplers is not so limited. The multiplexed volume hologram couplers described herein may be used for input couplers, output couplers, waveguide assemblies, or any combination thereof for other types of waveguide assemblies besides those used in augmented reality glasses. For example, the techniques described herein may be used in optics systems to process optical signals.

While various implementations have been described above, it should be understood that they have been presented by way of example only, and not limitation. For example, any of the elements associated with the systems and methods described above may employ any of the desired functionality set forth hereinabove. Thus, the breadth and scope of a preferred implementation should not be limited by any of the above-described sample implementations.

Those skilled in the art will appreciate that while the disclosure contained herein pertains to electronic eyewear devices having waveguides, it should be understood that this is only one of many possible applications, and other configurations are possible. Accordingly, all such applications are included within the scope of the following claims.

What is claimed is:

1. A coupler for a waveguide comprising:
at least two gratings within a three-dimensional (3D) volume, each grating responsive to input light of different wavelengths to reflect or transmit the input light into or out of the waveguide, each grating within the 3D volume having at least one of a (1) same periodicity but a different orientation or (2) a same orientation but a different periodicity, to provide a different refractive index relative to each other grating within the 3D volume.

2. The coupler of claim 1, wherein the coupler is an input coupler and the waveguide propagates light at angles of incidence greater than a critical angle at which total internal reflection occurs, each grating being oriented to receive an input light wave at an angle of incidence to the waveguide that is less than the critical angle and that transmits or reflects the input light wave to form an output light wave that propagates in the waveguide at an angle of incidence greater than the critical angle.

3. The coupler of claim 2, wherein at least one of the gratings has a refractive index that diffracts the output light wave at a second interaction with the input coupler whereby the diffracted output light wave has the angle of incidence greater than the critical angle.

4. The coupler of claim 1, wherein the coupler is an input coupler and the waveguide propagates light at angles of incidence greater than a critical angle at which total internal reflection occurs, each grating being oriented to receive an input light wave at an angle of incidence that is greater than the critical angle and that transmits or reflects the input light wave to form an output light wave that propagates in the waveguide at an angle of incidence greater than the critical angle and different than the angle of incidence of the input light wave.

5. The coupler of claim 1, wherein the coupler is an output coupler and the waveguide propagates light at angles of incidence greater than a critical angle at which total internal reflection occurs, each grating being oriented to receive an input light wave from the waveguide at an angle of incidence greater than the critical angle and that transmits or reflects the input light wave to form an output light wave that has an angle of incidence less than the critical angle so as to escape the waveguide.

6. The coupler of claim 5, wherein the output coupler extends in a propagation direction of the input light wave within the waveguide so as to have at least two interactions with the input light wave as the input light wave propagates in the propagation direction within the waveguide.

7. The coupler of claim 6, wherein the output coupler has a diffraction efficiency profile as a function of length that is adapted to control an intensity of the output light wave at each interaction with the output coupler whereby light output by the output coupler has a desired intensity profile along the length of the output coupler.

8. A waveguide assembly, comprising:
a waveguide that propagates light at angles of incidence greater than a critical angle at which total internal reflection occurs;
an input coupler comprising at least two gratings within a first three-dimensional (3D) volume, each grating within the first 3D volume being responsive to input light of different wavelengths to reflect or transmit the input light into the waveguide as propagating light, each grating within the first 3D volume having at least one of a (1) same periodicity but a different orientation or (2) a same orientation but a different periodicity, to provide a different refractive index relative to each other grating within the first 3D volume; and
an output coupler comprising at least two gratings within a second 3D volume, each grating within the second 3D volume being responsive to propagating light of different wavelengths propagating in the waveguide within an angle of incidence of the output coupler at which the propagating light is reflected or transmitted out of the waveguide, each grating within the second 3D volume having at least one of a (1) same periodicity but a different orientation or (2) a same orientation but a different periodicity, to provide a different refractive index relative to each other grating within the second 3D volume.

9. The waveguide assembly of claim 8, wherein the propagating light output by the input coupler is reflected or transmitted by the waveguide to the output coupler, whereby the reflected or transmitted propagating light output by the input coupler has an angle of incidence that is within an acceptance angle of the output coupler upon interaction with the output coupler.

10. The waveguide assembly of claim 8, wherein the output coupler extends in a propagation direction of the propagating light within the waveguide so as to have at least two interactions with the propagating light as the propagating light propagates in the propagation direction within the waveguide.

11. The waveguide assembly of claim 10, wherein the refractive index of each grating of the second 3D volume has a value whereby the propagating light at the different wavelengths may be reflected or transmitted by the output coupler to an angle less than the critical angle so as to escape the waveguide.

12. The waveguide assembly of claim 11, wherein the output coupler has a diffraction efficiency profile as a function of length that is adapted to control an intensity of the propagating light at each interaction with the output coupler whereby light output by the output coupler has a desired intensity profile along the length of the output coupler.

13. The waveguide assembly of claim 8, wherein the input coupler further comprises a volume holographic fold grating that simultaneously folds and splits an incident input light wave into two light waves that are turned around an axis perpendicular to a plane including the waveguide.

14. The waveguide assembly of claim 13, wherein the volume holographic fold grating reflects or transmits the two light waves output by the volume holographic fold grating to propagate in the waveguide within the angle of incidence of the output coupler.

15. The waveguide assembly of claim 8, wherein the output coupler further comprises a volume holographic fold grating that simultaneously folds and splits the propagating light into two light waves that are turned around an axis perpendicular to a plane including the waveguide and outcouples the folded and split light out of the waveguide.

16. The waveguide assembly of claim 15, wherein the output coupler further comprises at least two multiplexed volume holographic fold gratings that are each matched to a different propagation direction in the waveguide and that fold received propagating light to outcouple the folded light in each direction.

17. The waveguide assembly of claim 16, wherein the input coupler further comprises a volume holographic fold grating that simultaneously folds and splits the propagating light into at least two light waves that are turned around the axis perpendicular to the plane including the waveguide and are outcoupled out of the waveguide by the output coupler.

18. The waveguide assembly of claim 17, wherein the input coupler is disposed in a first layer of the waveguide and the output coupler is disposed in a second layer of the waveguide, wherein the second layer is different from the first layer.

19. The waveguide assembly of claim 8, wherein the input coupler comprises at least two volume holographic fold gratings oriented to receive an input light wave incident at an angle of incidence to the waveguide that is less than the critical angle of the waveguide and that transmits or reflects the input light wave to form an output light wave that propagates in the waveguide at an angle of incidence greater than the critical angle and different than the angle of incidence of the input light wave, and the output coupler comprises at least two volume holographic fold gratings oriented to receive propagating light from the waveguide at an angle of incidence greater than the critical angle and that transmits or reflects the propagating light to form an output light wave that has an angle of incidence less than the critical angle so as to escape the waveguide.

20. An eyewear device, comprising:
an image source;
a display comprising an eye box;
a waveguide that propagates light at angles of incidence greater than a critical angle at which total internal reflection occurs;
an input coupler comprising at least two gratings within a first three-dimensional (3D) volume, each grating with the first 3D volume responsive to input light of different wavelengths from the image source to reflect or transmit the input light into the waveguide as propagating light, each grating within the first 3D volume having at least one of a (1) same periodicity but a different orientation or (2) a same orientation but a different periodicity, to provide a different refractive index relative to each other grating within the first 3D volume; and
an output coupler comprising at least two gratings within a second 3D volume, each grating within the second 3D volume responsive to propagating light of different wavelengths propagating in the waveguide within an angle of incidence of the output coupler at which propagating light is reflected or transmitted out of the waveguide to the eye box of the display, each grating within the second 3D volume having at least one of a (1) same periodicity but a different orientation or (2) a same orientation but a different periodicity, to provide a different refractive index relative to each other grating within the second 3D volume.
